(19) United States
(12) Patent Application Publication
(10) Pub. No.: US 2012/0137838 A1
(43) Pub. Date: Jun. 7, 2012

(54) Wrench and system and method for connecting a wrench to an adjacent object

(76) Inventor: Raymond Mullins, Bourbonnais, IL (US)

(21) Appl. No.: 12/928,217

(22) Filed: Dec. 7, 2010

(51) Int. Cl. B25B 23/00

(52) U.S. Cl. 81/180.1

(57) ABSTRACT

A wrench may have a cord extending from the wrench to tether the wrench to an adjacent object. The first end of the wrench may be configured to enclose a nut or a bolt. The second end of the wrench may have one or more holes through which the cord may be inserted. Each end of the cord may have a hook. The cord and/or the hooks may be used to secure the second end of the wrench to the adjacent object. Cords having different lengths may be provided so that a distance between the second end of the wrench and the adjacent object may be accommodated.

### BACKGROUND OF THE INVENTION

The present invention generally relates to a wrench and a system and a method for connecting a wrench to an adjacent object. More specifically, the present invention relates to a wrench which may be tethered to an adjacent stationary object.

It is generally known that a nut is a fastener having a threaded hole, and the threads of the nut may insert between threads of a bolt to connect the nut to the bolt. Rotation of the nut in a first direction relative to the bolt may connect the nut to the bolt and/or tighten the nut on the bolt. Rotation of the nut in an opposite direction relative to the bolt may loosen the nut on the bolt and/or remove the nut from the bolt.

However, rotating the nut relative to the bolt may be difficult. For example, a first implement may be used on one side of the bolt to prevent the nut or the bolt from rotating, and a second implement may be used on the opposite side of the bolt to apply torque to the nut or the bolt. Holding and/or using both implements may be difficult for one person, and applying sufficient torque with one hand to tighten or loosen the nut may be difficult. For example, both hands may be required to use the second implement to apply torque to the nut or the bolt; accordingly, the person may not be able to hold the first implement while using the second implement. Alternatively, two individuals may tighten or loosen the nut. For example, a first person may use a first wrench to prevent rotation of the nut or the bolt while a second person applies torque to the nut or the bolt head using a second wrench. However, a second person may not be available, and using two individuals to tighten or loosen the nut may be time consuming and labor intensive. Therefore, a need exists for a wrench which connects to an adjacent object and a system and a method for connecting a wrench to an adjacent object.

### SUMMARY OF THE INVENTION

The present invention generally relates to a wrench and a system and a method for connecting a wrench to an adjacent object. More specifically, the present invention relates to a wrench which may be tethered to an adjacent object. The first end of the wrench may be configured to enclose a nut or a bolt. The second end of the wrench may have one or more holes through which a cord may be inserted. Each end of the cord may have a hook. The cord and/or the hooks may be used to secure the second end of the wrench to the adjacent object. Cords having different lengths may be provided so that a distance between the second end of the wrench and the adjacent object may be accommodated.

To this end, in an embodiment of the present invention, a wrench is provided. The wrench has a central body having a rectangular shape wherein the central body has a first end and a second end and further wherein the first end of the central body is located in a position opposite to the second end of the central body wherein the central body has a first side and a second side and further wherein the first side of the central body is located in a position opposite to the second side of the central body; an open end portion connected to the first end of the central body wherein the open end portion has a first opposing face and a second opposing face wherein the open end portion has a first side and a second side and further wherein the first side of the open end portion is located in a position opposite to the second side of the open end portion; a first hole extending from the first side of the central body to the second side of the central body wherein the first hole is located at the second end of the central body; a cord extending through the first hole wherein the cord has a first end and a second end and further wherein the first end of the cord is located in a position opposite to the second end of the cord; and a first hook connected to the first end of the cord wherein the first hook has a first leg and a second leg and further wherein the first leg is substantially parallel to the second leg wherein the first leg is integrally connected to the second leg by a bent portion of the first hook and further wherein the bent portion is angled relative to the first leg and the second leg.

In an embodiment, the wrench has a second hole which extends from the first side of the central body to the second side of the central body wherein the second hole is located at the second end of the central body.

In an embodiment, the wrench has a second hook connected to the second end of the cord wherein the second hook has a first leg and a second leg and further wherein the first leg is substantially parallel to the second leg wherein the first leg is connected to the second leg by a bent portion of the second hook and further wherein the bent portion is angled relative to the first leg and the second leg.

In an embodiment, the second side of the open end portion is substantially coplanar with the second side of the central body.

In an embodiment, the first side of the open end portion is angled relative to the first side of the central body.

In an embodiment, the first opposing face and the second opposing face are approximately the same size.

In an embodiment, the wrench has an additional cord which extends through a second hole adjacent to the first hole wherein the additional cord has a different length than the cord.

In another embodiment of the present invention, a system for connecting a wrench to an adjacent object is provided. The system has a central body having a first end and a second end wherein the first end of the central body is located in a position opposite to the second end of the central body and further wherein the central body has a first side and a second side wherein the first side of the central body is located in a position opposite to the second side of the central body; a box end portion connected to the first end of the central body wherein the box end portion has a first side and a second side and further wherein the first side of the open end portion is located in a position opposite to the second side of the open end portion wherein the box end portion has an opening which extends from the first side of the box end portion to the second side of the box end portion; a first hole which extends from the first side of the central body to the second side of the central body wherein the first hole is located at the second end of the central body; a first cord which extends through the first hole wherein the first cord has a first end and a second end and further wherein the first end of the first cord is located in a position opposite to the second end of the first cord; a first hook connected to the first end of the first cord wherein a first portion of the first hook is connected to the first end of the first cord and further wherein a second portion of the first hook is angled relative to the first portion of the first hook; and a second hook connected to the second end of the first cord wherein a first portion of the second hook is connected to the second end of the first cord and further wherein a second portion of the second hook is angled relative to the first portion of the second hook.

In an embodiment, the system has ridges connected to the box end portion wherein the ridges extend into the opening.

In an embodiment, the first hole is located between the first end of the first cord and the second end of the first cord.

In an embodiment, the first side of the box end portion is angled at four degrees relative to the first side of the central body.

In an embodiment, the system has a second cord having a different length than the first cord wherein the second cord extends through a second hole in the central body and further wherein the second hole extends from the first side of the central body to the second side of the central body.

In an embodiment, the system has a second cord having a different length than the first cord wherein the second cord has a plurality of hooks.

In an embodiment, a method for connecting a wrench to an adjacent object is provided. The method has the steps of connecting a first end of the wrench to one of a nut and a bolt; connecting a first cord to the adjacent object after connecting the first end of the wrench to the one of the nut and the bolt wherein the first cord extends from a second end of the wrench and further wherein the second end of the wrench is located in a position opposite to the first end of the wrench wherein the first cord is connected to the adjacent object using a first hook which is attached to the first cord; removing the first end of the wrench from the one of the nut and the bolt; and disconnecting the first cord from the adjacent object.

In an embodiment, the method has the step of rotating the nut with an additional implement while the first end of the wrench is connected to the bolt on which the nut is located wherein the nut is rotated after connecting the first cord to the adjacent object.

In an embodiment, the method has the step of rotating the bolt with an additional implement while the first end of the wrench is connected to the nut located on the bolt wherein the bolt is rotated after connecting the first cord to the adjacent object.

In an embodiment, the method has the step of disconnecting the first hook from one of the first cord and a second hook connected to the first cord to disconnect the second end of the wrench from the adjacent object.

In an embodiment, the method has the step of replacing the first cord with a second cord which has a different length than the first cord.

In an embodiment, the method has the step of connecting the second end of the wrench to an additional adjacent object using a second cord which extends from the second end of the wrench.

In an embodiment, the method has the step of using a second hook to connect the wrench to the adjacent object wherein the second hook is connected to the first cord.

It is, therefore, an advantage of the present invention to provide a wrench and a system and a method for connecting a wrench to an adjacent object.

Another advantage of the present invention is to provide a wrench and a system and a method for connecting a wrench to an adjacent object which may reversibly connect and disconnect the wrench from the adjacent object.

Yet another advantage of the present invention is to provide a wrench and a system and a method for connecting a wrench to an adjacent object which may accommodate the distance between the wrench and the adjacent object using a cord selected from cords having different lengths.

A still further advantage of the present invention is to provide a wrench and a system and a method for connecting a wrench to an adjacent object which may prevent rotation of a bolt while a person uses two hands to rotate a nut on the bolt.

Another advantage of the present invention is to provide a wrench and a system and a method for connecting a wrench to an adjacent object which may enable a person to rotate a nut relative to a bolt without the assistance of an additional person.

Yet another advantage of the present invention is to provide a wrench and a system and a method for connecting a wrench to an adjacent object which may accommodate the distance between the wrench and the adjacent object using a stretchable cord which extends through the wrench.

A still further advantage of the present invention is to provide a wrench and a system and a method for connecting a wrench to an adjacent object which may use hooks to connect the wrench to the adjacent object.

Moreover, an advantage of the present invention is to provide a wrench and a system and a method for connecting a wrench to an adjacent object which may be stored with ease.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a wrench in an embodiment of the present invention.

FIG. 2 illustrates a side view of a wrench in an embodiment of the present invention.

FIG. 3 illustrates a perspective view of a wrench in an embodiment of the present invention.

FIG. 4 illustrates a side view of a wrench in an embodiment of the present invention.

FIGS. 5 and 6 illustrate perspective views of a wrench used with a nut on a bolt in embodiments of the present invention.

### DETAILED DESCRIPTION OF THE PRESENTLY PREFERRED EMBODIMENTS

The present invention generally relates to a wrench and a system and a method for connecting a wrench to an adjacent object. More specifically, the present invention relates to a wrench which may be tethered to an adjacent object. The first end of the wrench may be configured to enclose a nut or a bolt. The second end of the wrench may have one or more holes through which a cord may travel. Each end of the cord may have a hook. The cord and/or the hooks may be used to secure the second end of the wrench to the adjacent object. Cords having different lengths may be provided so that a distance between the second end of the wrench and the adjacent object may be accommodated.

The wrench may be used by placing the first end of the wrench on the bolt. Then, the cord and/or the hooks may be used to secure the second end of the wrench to the adjacent object. The second end of the wrench may be secured by the cord and/or the hooks so that tension is applied in the opposite direction in which a nut on the bolt is turned. As a result, the wrench may prevent rotation of the bolt. Another implement may be applied to the nut to turn the nut relative to the bolt. After the nut is removed from or tightened on the bolt, the cord and/or the hooks may be removed from the adjacent object, and the first end of the wrench may be removed from the bolt to enable the wrench to be removed and/or stored.

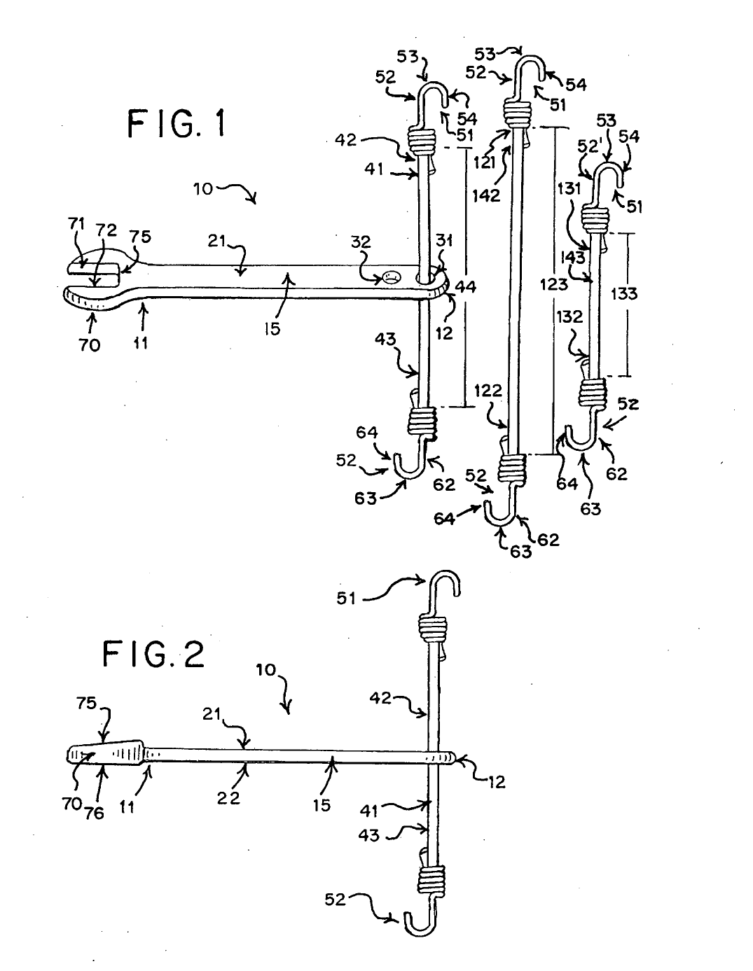

Referring now to the drawings wherein like numerals refer to like parts, FIGS. 1-4 generally illustrate embodiments of a wrench 10 which may have a first end 11 and may have a second end 12. The second end 12 may be located in a position opposite to the first end 11. The wrench 10 may have a central body 15 which may be located between the first end 11 and the second end 12. In an embodiment, the central body 15 may have a rectangular shape. The central body 15 may have any shape, and the present invention is not limited to a specific shape of the central body 15.

The central body 15 may have a first side 21 and may have a second side 22. The second side 22 may be located in a position opposite to the first side 21. The first side 21 of the central body 15 may be substantially parallel to the second side 22 of the central body 15. The wrench 15 may have a first hole 31 and/or a second hole 32 which may be located at the second end 12 of the wrench 15. In an embodiment, the first hole 31 and/or the second hole 32 may have a width of a quarter of an inch. The first hole 31 and/or the second hole 32 may extend from the first side 21 of the central body 15 to the second side 22 of the central body 15. The present invention is not limited to a specific width of first hole 31 or the second hole 32 or a specific number of holes extending from the first side 21 of the central body 15 to the second side 22 of the central body 15. The width of the first hole 31 and/or the second hole 32 may be any distance, and the central body 15 may have any number of holes.

A first cord 41 may extend through the first hole 31. In an embodiment, the first cord 41 may be flexible and/or may be extendable. For example, the first cord 41 may be made from one or more strands of an elastic material which may be bound together by a fabric covering. The elastic material may be, for example, natural rubber and/or synthetic rubber. The first cord 41 may be made from any material, and the present invention is not limited to a specific material of the first cord 41.

The first cord 41 may have a first end 42 and may have a second end 43. The second end 43 may be located in a position opposite to the first end 42. The first end 42 and the second end 43 may define a length 44 of the first cord 41. A first hook 51 and/or a second hook 52 may be connected to the first end 42 and/or the second end 43 of the first cord 41, respectively.

The first hook 51 may have a first leg 52, a bent portion 53 and/or a second leg 54. The first leg 52 of the first hook 51 may be connected to the first end 42 of the first cord 41. The bent portion 53 may connect the first leg 52 to the second leg 54. The bent portion 53 may be angled relative to the first leg 52 and/or the second leg 54. In an embodiment, the first leg 52 may be substantially parallel to the second leg 54. In an embodiment, an entirety of the first leg 52 may be substantially co-linear, and/or an entirety of the second leg 54 may be substantially co-linear.

The second hook 52 may have a first leg 62, a bent portion 63 and/or a second leg 64. The first leg 62 of the second hook 52 may be connected to the second end 43 of the first cord 41. The bent portion 53 may connect the first leg 62 to the second leg 64. The bent portion 63 may be angled relative to the first leg 62 and/or the second leg 64. In an embodiment, the first leg 62 may be substantially parallel to the second leg 64. In an embodiment, an entirety of the first leg 62 may be substantially co-linear, and/or an entirety of the second leg 64 may be substantially co-linear.

As shown in FIGS. 1 and 2, an embodiment of the wrench 10 may have an open end portion 70 which may be located at the first end 11 of the wrench 10. In an embodiment, the open end portion 70 may be integral with the central body 15 of the wrench 10. The open end portion 70 may have a first opposing face 71 and may have a second opposing face 72. In a preferred embodiment, the first opposing face 71 may be substantially parallel to the second opposing face 72, and/or the first opposing face 71 may have the same size and/or the same shape as the second opposing face 72.

The open end portion 70 may have a first side 75 and may have a second side 76. The first side 75 may be located in a position opposite to the second side 76. In an embodiment, the second side 76 of the open end portion 70 may be substantially coplanar with the second side 12 of the central body 15. In an embodiment, the first side 75 of the open end portion 70 may be angled relative to the first side 11 of the central body 15. For example, the first side 75 of the open end portion 70 may be angled approximately four degrees relative to the first side 11 of the central body 15. The present invention is not limited to a specific position of the first side 75 and the second side 76 of the open end portion 70.

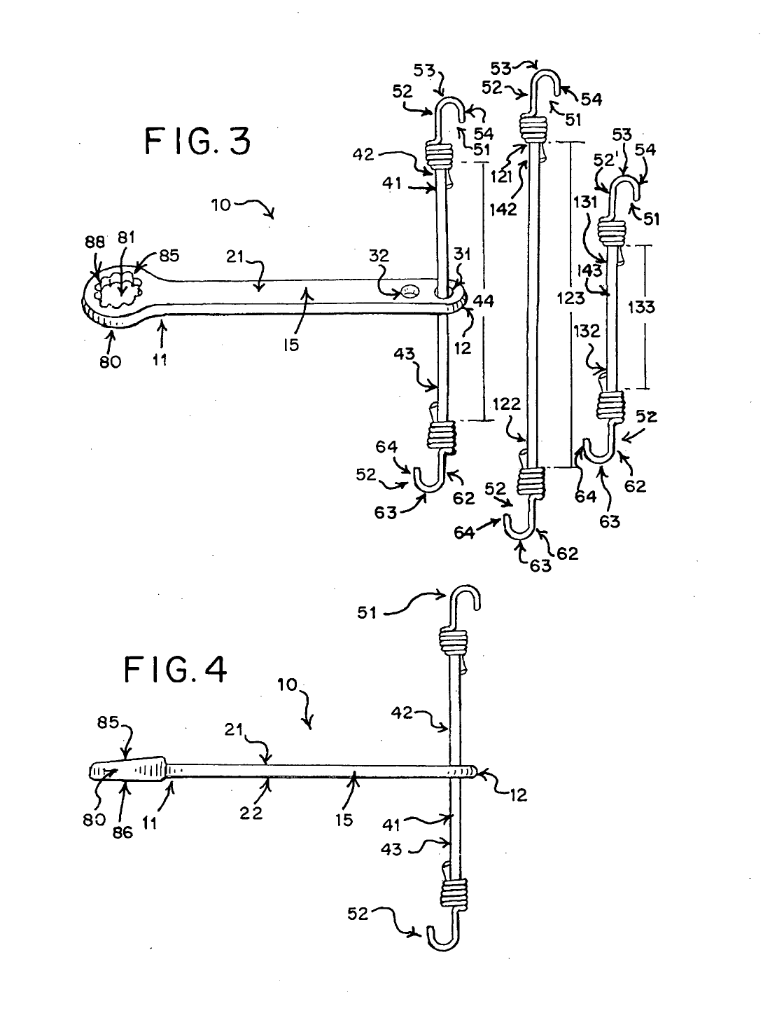

As shown in FIGS. 3 and 4, an embodiment of the wrench 10 may have a box end portion 80 which may be located at the first end 11 of the wrench 10. In an embodiment, the box end portion 80 may be integral with the central body 15 of the wrench 10. The box end portion 80 may have a first side 85 and may have a second side 86. The first side 85 may be located in a position opposite to the second side 86. In an embodiment, the second side 86 of the box end portion 80 may be substantially coplanar with the second side 12 of the central body 15. In an embodiment, the first side 85 of the box end portion 80 may be angled relative to the first side 11 of the central body 15. For example, the first side 85 of the box end portion 80 may be angled approximately four degrees relative to the first side 11 of the central body 15. The present invention is not limited to a specific position of the first side 85 and the second side 86 of the box end portion 80.

The box end portion 80 may have an opening 81 which may extend from the first side 85 of the box end portion 80 to the second side 86 of the box end portion 80. The opening 81 of the box end portion 80 may have ridges 88 which may extend into the opening 81. For example, the opening 81 of the box end portion 80 may have six, eight, twelve or sixteen of the ridges 88. The present invention is not limited to a specific number of the ridges 88, and the hole 81 of the box end portion 80 may have any number of the ridges 88.

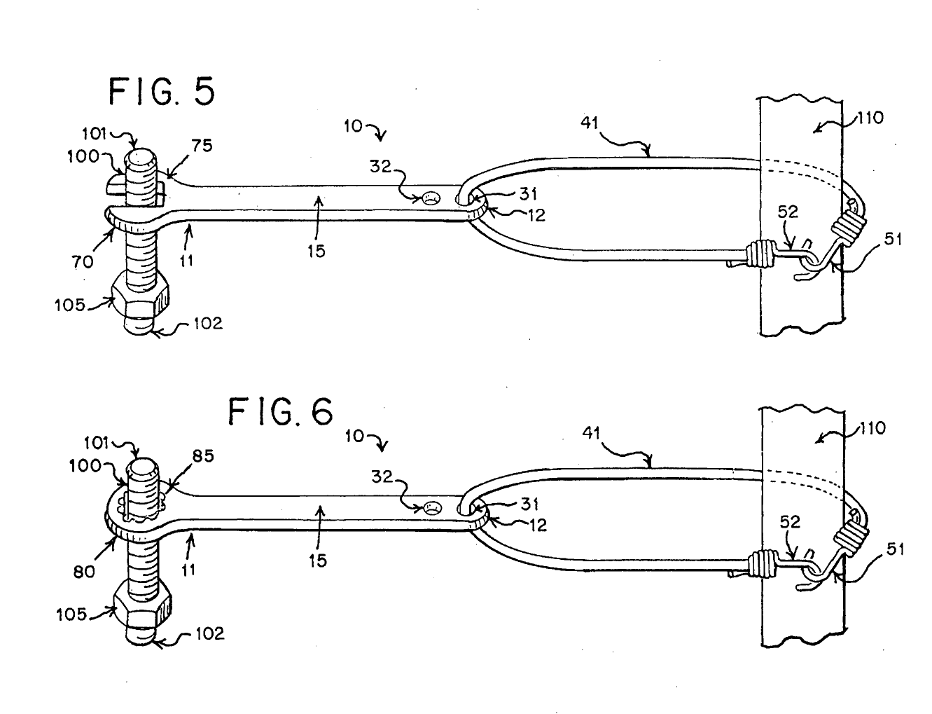

Referring to FIG. 5, the open end portion 70 of the wrench 10 may be connected to a first end 101 of a bolt 100. For example, the first end 11 of the wrench 10 may be positioned so that the first end 101 of the bolt 100 and/or a bolt head (not shown) on the first end 101 of the bolt 100 may be located between the first opposing face 71 and the second opposing face 72. Then, the first cord 41 may be used to connect the second end 12 of the wrench 10 to an adjacent object 110. For example, the first cord 41 of the wrench 10 may be positioned so that the adjacent object 110 may be located between the first hook 51 and the second hook 52. The first hook 51 may connect to the first cord 41 and/or the second hook 52, and/or the first hook 51 may connect to the first cord 41 and/or the second hook 52 to secure the first cord 41 to the adjacent object 100. For example, the bent portion 53 of the first hook 51 may be positioned between the first leg 62 and the second leg 64 of the second hook 52. The bent portion 63 of the second hook 52 may be positioned between the first leg 52 and the second leg 54 of the first hook 51.

Connecting the open end portion 70 of the wrench 10 to the first end 101 of a bolt 100 and/or connecting the second end 12 of the wrench 10 to the adjacent object 110 may maintain a position of the bolt 100. For example, the wrench 10 may prevent rotation of the bolt 100. As a result, a nut 105 located on the second end 102 of the bolt 100 may be rotated without rotation of the bolt 100. For example, a user may apply a second implement (not shown) to rotate the nut 105 while the wrench 10 prevents rotation of the bolt 100, and the user may use both hands to use the second implement.

After the nut 105 is rotated, the open end portion 70 of the wrench 10 may be removed from the first end 101 of the bolt 100, and/or the second end 12 of the wrench 10 may be disconnected from the adjacent object 110. For example, the first hook 51 may be disconnected from the first cord 41 and/or the second hook 52, and/or the first hook 51 may be disconnected from the first cord 41 and/or the second hook 52. Removal of the open end portion 70 of the wrench from the first end 101 of the bolt 100 and/or disconnecting the second end 12 of the wrench 10 from the adjacent object 110 may enable the wrench 10 to be stored.

Alternatively, the open end portion 70 of the wrench 10 may be connected to the nut 105. For example, the first end 11 of the wrench 10 may be positioned so that the nut 105 may be located between the first opposing face 71 and the second opposing face 72. Then, the first cord 41 may be used to connect the second end 12 of the wrench 10 to an adjacent object 110. Connecting the open end portion 70 of the wrench 10 to the nut 105 and/or connecting the second end 12 of the wrench 10 to the adjacent object 110 may maintain a position of the nut 105. For example, the wrench 10 may prevent rotation of the nut 105. As a result, the bolt 100 may be rotated without rotation of the nut 105. For example, a user may apply a second implement (not shown) to rotate the bolt 100 while the wrench 10 prevents rotation of the nut 105, and the user may use both hands to use the second implement.

After the bolt 100 is rotated, the open end portion 70 of the wrench 10 may be removed from the nut 105, and/or the second end 12 of the wrench 10 may be disconnected from the adjacent object 110. For example, the first hook 51 may be disconnected from the first cord 41 and/or the second hook 52, and/or the first hook 51 may be disconnected from the first cord 41 and/or the second hook 52. Removal of the open end portion 70 of the wrench 10 from the nut and/or disconnecting the second end 12 of the wrench 10 from the adjacent object 110 may enable the wrench 10 to be stored.

Referring to FIG. 6, the box end portion 80 of the wrench 10 may be connected to the first end 101 of the bolt 100. For example, the first end 11 of the wrench 10 may be positioned so that the first end 101 of the bolt 100 and/or a bolt head (not shown) on the first end 101 of the bolt 100 may be located within the opening 81 and/or between the ridges 88. Then, the first cord 41 may be used to connect the second end 12 of the wrench 10 to an adjacent object 110. For example, the first cord 41 of the wrench 10 may be positioned so that the adjacent object 110 may be located between the first hook 51 and the second hook 52. The first hook 51 may connect to the first cord 41 and/or the second hook 52, and/or the first hook 51 may connect to the first cord 41 and/or the second hook 52 to secure the first cord 41 to the adjacent object 100. For example, the bent portion 53 of the first hook 51 may be positioned between the first leg 62 and the second leg 64 of the second hook 52. The bent portion 63 of the second hook 52 may be positioned between the first leg 52 and the second leg 54 of the first hook 51.

Connecting the box end portion 80 of the wrench 10 to the first end 101 of a bolt 100 and/or connecting the second end 12 of the wrench 10 to the adjacent object 110 may maintain a position of the bolt 100. For example, the wrench 10 may prevent rotation of the bolt 100. As a result, the nut 105 located on the second end 102 of the bolt 100 may be rotated without rotation of the bolt 100. For example, a user may apply a second implement (not shown) to rotate the nut 105 while the wrench 10 prevents rotation of the bolt 100, and the user may use both hands to use the second implement.

After the nut 105 is rotated, the box end portion 80 of the wrench 10 may be removed from the first end 101 of the bolt 100, and/or the second end 12 of the wrench 10 may be disconnected from the adjacent object 110. For example, the first hook 51 may be disconnected from the first cord 41 and/or the second hook 52, and/or the first hook 51 may be disconnected from the first cord 41 and/or the second hook 52. Removal of the box end portion 80 of the wrench from the first end 101 of the bolt 100 and/or disconnecting the second end 12 of the wrench 10 from the adjacent object 110 may enable the wrench 10 to be stored.

Alternatively, the box end portion 80 of the wrench 10 may be connected to the nut 105. For example, the first end 11 of the wrench 10 may be positioned so that the nut 105 may be located within the opening 81 and/or between the ridges 88. Then, the first cord 41 may be used to connect the second end 12 of the wrench 10 to an adjacent object 110. Connecting the box end portion 80 of the wrench 10 to the nut and/or connecting the second end 12 of the wrench 10 to the adjacent object 110 may maintain a position of the nut 105. For example, the wrench 10 may prevent rotation of the nut 105. As a result, the bolt 100 may be rotated without rotation of the nut 105. For example, a user may apply a second implement (not shown) to rotate the bolt 100 while the wrench 10 prevents rotation of the nut 105, and the user may use both hands to use the second implement.

After the bolt 100 is rotated, the box end portion 80 of the wrench 10 may be removed from the nut 105, and/or the second end 12 of the wrench 10 may be disconnected from the adjacent object 110. For example, the first hook 51 may be disconnected from the first cord 41 and/or the second hook 52, and/or the first hook 51 may be disconnected from the first cord 41 and/or the second hook 52. Removal of the box end portion 80 of the wrench 10 from the nut and/or disconnecting the second end 12 of the wrench 10 from the adjacent object 110 may enable the wrench 10 to be stored.

Referring again to FIGS. 1 and 3, a second cord 142 and/or a third cord 143 may be used with the wrench 10. In an embodiment, the second cord 142 and/or the third cord 143 may be flexible and/or may be extendable. For example, the second cord 142 and/or the third cord 143 may be made of one or more strands of an elastic material which may be bound together by a fabric covering. The elastic material may be, for example, natural rubber and/or synthetic rubber. The second cord 142 and/or the third cord 143 may be made from any material, and the present invention is not limited to a specific material of the second cord 142 or the third cord 143.

The second cord 142 may have a first end 121 and may have a second end 122. The first end 121 may be located in a position opposite to the second end 122. The first end 121 and the second end 122 may define a length 123 of the second cord 142. The third cord 143 may have a first end 131 and may have a second end 132. The first end 131 may be located in a position opposite to the second end 132. The first end 131 and the second end 132 may define a length 133 of the third cord 143.

In an embodiment, the length 123 of the second cord 142 may be a larger distance than the length 44 of the first cord 41, and/or the length 133 of the third cord 143 may be a smaller distance than the length 44 of the first cord 41. A user may accommodate the distance from the second end 12 of the wrench 10 to the adjacent object 110 by selecting from the first cord 41, the second cord 142 and/or the third cord 143. For example, the user may select one of the first cord 41, the second cord 142 and the/or the third cord 143 so that the length of the selected cord may enable the selected cord to connect the second end 12 of the wrench 10 to the adjacent object 110.

For example, if the length 44 of the first cord 41 is too small to connect the second end 12 of the wrench 10 to the adjacent object 110, the second cord 142 may be used to connect the second end 12 of the wrench 10 to the adjacent object 110. In an embodiment, the first cord 41 may be replaced with the second cord 142. For example, the first cord 41 may be removed from the first hole 31, and/or the second cord 142 may be inserted through the first hole 31. In another embodiment, the second cord 142 may extend through the second hole 32 so that removal of the first cord 41 from the first hole 31 may not be required.

As another example, if the length 44 of the first cord 41 is too large to resist movement of the second end 12 of the wrench 10 relative to the adjacent object 110, the third cord 143 may be used to connect the second end 12 of the wrench 10 to the adjacent object 110. In an embodiment, the first cord 41 may be replaced with the third cord 143. For example, the first cord 41 may be removed from the first hole 31, and/or the third cord 143 may be inserted through the first hole 31. In another embodiment, the third cord 143 may extend through the second hole 32 so that removal of the first cord 41 from the first hole 31 may not be required.

In an embodiment, one or more of the first cord 41, the second cord 142 and/or the third cord 143 may be a different color to assist the user in identification of a desired cord. The present invention is not limited to a specific number of cords, and any number of cords may be provided and may extend through holes in the wrench to accommodate the distance from the second end 12 of the wrench 10 to the adjacent object 110.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A wrench comprising:
a central body having a rectangular shape wherein the central body has a first end and a second end and further wherein the first end of the central body is located in a position opposite to the second end of the central body wherein the central body has a first side and a second side and further wherein the first side of the central body is located in a position opposite to the second side of the central body;
an open end portion connected to the first end of the central body wherein the open end portion has a first opposing face and a second opposing face wherein the open end portion has a first side and a second side and further wherein the first side of the open end portion is located in a position opposite to the second side of the open end portion;
a first hole extending from the first side of the central body to the second side of the central body wherein the first hole is located at the second end of the central body;
a cord extending through the first hole wherein the cord has a first end and a second end and further wherein the first end of the cord is located in a position opposite to the second end of the cord; and
a first hook connected to the first end of the cord wherein the first hook has a first leg and a second leg and further wherein the first leg is substantially parallel to the second leg wherein the first leg is integrally connected to the second leg by a bent portion of the first hook and further wherein the bent portion is angled relative to the first leg and the second leg.

2. The wrench of claim 1 further comprising:
a second hole which extends from the first side of the central body to the second side of the central body wherein the second hole is located at the second end of the central body.

3. The wrench of claim 1 further comprising:
a second hook connected to the second end of the cord wherein the second hook has a first leg and a second leg and further wherein the first leg is substantially parallel to the second leg wherein the first leg is connected to the second leg by a bent portion of the second hook and further wherein the bent portion is angled relative to the first leg and the second leg.

4. The wrench of claim 1 wherein the second side of the open end portion is substantially coplanar with the second side of the central body.

5. The wrench of claim 1 wherein the first side of the open end portion is angled relative to the first side of the central body.

6. The wrench of claim 1 wherein the first opposing face and the second opposing face are approximately the same size.

7. The wrench of claim 1 further comprising:
an additional cord which extends through a second hole adjacent to the first hole wherein the additional cord has a different length than the cord.

8. A system for connecting a wrench to an adjacent object, the system comprising:
a central body having a first end and a second end wherein the first end of the central body is located in a position opposite to the second end of the central body and further wherein the central body has a first side and a second side wherein the first side of the central body is located in a position opposite to the second side of the central body;
a box end portion connected to the first end of the central body wherein the box end portion has a first side and a second side and further wherein the first side of the open end portion is located in a position opposite to the second side of the open end portion wherein the box end portion has an opening which extends from the first side of the box end portion to the second side of the box end portion;
a first hole which extends from the first side of the central body to the second side of the central body wherein the first hole is located at the second end of the central body;
a first cord which extends through the first hole wherein the first cord has a first end and a second end and further wherein the first end of the first cord is located in a position opposite to the second end of the first cord;
a first hook connected to the first end of the first cord wherein a first portion of the first hook is connected to the first end of the first cord and further wherein a second portion of the first hook is angled relative to the first portion of the first hook; and
a second hook connected to the second end of the first cord wherein a first portion of the second hook is connected to the second end of the first cord and further wherein a second portion of the second hook is angled relative to the first portion of the second hook.

9. The system of claim 8 further comprising:
ridges connected to the box end portion wherein the ridges extend into the opening.

10. The system of claim 8 wherein the first hole is located between the first end of the first cord and the second end of the first cord.

11. The system of claim 8 wherein the first side of the box end portion is angled at four degrees relative to the first side of the central body.

12. The system of claim 8 further comprising:
a second cord having a different length than the first cord wherein the second cord extends through a second hole in the central body and further wherein the second hole extends from the first side of the central body to the second side of the central body.

13. The system of claim 8 further comprising:
a second cord having a different length than the first cord wherein the second cord has a plurality of hooks.

14. A method for connecting a wrench to an adjacent object, the method comprising the steps of:
connecting a first end of the wrench to one of a nut and a bolt;
connecting a first cord to the adjacent object after connecting the first end of the wrench to the one of the nut and the bolt wherein the first cord extends from a second end of the wrench and further wherein the second end of the wrench is located in a position opposite to the first end of the wrench wherein the first cord is connected to the adjacent object using a first hook which is attached to the first cord;
removing the first end of the wrench from the one of the nut and the bolt; and
disconnecting the first cord from the adjacent object.

15. The method of claim 14 further comprising the step of:
rotating the nut with an additional implement while the first end of the wrench is connected to the bolt on which the nut is located wherein the nut is rotated after connecting the first cord to the adjacent object.

16. The method of claim 14 further comprising the step of:
rotating the bolt with an additional implement while the first end of the wrench is connected to the nut located on the bolt wherein the bolt is rotated after connecting the first cord to the adjacent object.

17. The method of claim 14 further comprising the step of:
disconnecting the first hook from one of the first cord and a second hook connected to the first cord to disconnect the second end of the wrench from the adjacent object.

18. The method of claim 14 further comprising the step of:
replacing the first cord with a second cord which has a different length than the first cord.

19. The method of claim 14 further comprising the step of:
connecting the second end of the wrench to an additional adjacent object using a second cord which extends from the second end of the wrench.

20. The method of claim 14 further comprising the step of:
using a second hook to connect the wrench to the adjacent object wherein the second hook is connected to the first cord.
